(19) United States
(12) Patent Application Publication
(10) Pub. No.: US 2024/0327188 A1
(43) Pub. Date: Oct. 3, 2024

(54) DEVICE FOR OPENING A CANNED BEVERAGE AND METHOD OF USE THEREOF

(71) Applicant: Jamison Fuller, Denver, NC (US)

(72) Inventor: Jamison Fuller, Denver, NC (US)

(21) Appl. No.: 18/194,058

(22) Filed: Mar. 31, 2023

(51) Int. Cl. B67B 7/40

(52) U.S. Cl. CPC B67B 7/403

(57) ABSTRACT

A device for opening a canned beverage includes a main body, a tab cutout and a lifting prong. The main body has a top, a bottom, a front, and a back. The tab cutout is positioned in the front of the main body. The tab cutout is sized and configured to receive the tab of the canned beverage therein. The lifting prong is positioned inside of the tab cutout. The lifting prong is configured for sliding under the tab of the canned beverage when the tab is moved into the tab cutout. Whereby, the device is configured to open the canned beverage by lifting the tab with the lifting prong.

### FIELD OF THE DISCLOSURE

The present disclosure relates to canned beverages, like sodas, beer, or the like. More specifically, the present disclosure relates to a device for opening a canned beverage, like a soda can, beer can, or the like, and a method of use thereof

### BACKGROUND

Generally speaking, a beverage can or a drink can is a metal container designed to hold a fixed portion of liquid such as carbonated soft drinks, alcoholic drinks, fruit juices, teas, herbal teas, energy drinks, etc. Drink cans are typically made of aluminum. Most beverage cans, like soda cans and beer cans, include a standard stay-tab opening mechanism. This design uses a separate tab attached to the upper surface as a lever to depress a scored part of the lid, which folds underneath the top of the can and out of the way of the resulting opening, thus reducing injuries and roadside litter caused by removable tabs.

To open a beverage can with a stay-tab opening mechanism, the user generally grabs the can in one hand and uses their other hand to open the can. The user will typically slide their nail and/or fingertip up under the tab and rotate the tab upwards to depress the scored part of the lid, which then folds underneath the top of the can and out of the way of the resulting opening. The user then pushes the tab back down on top of the can for easier access to the opening for drinking or poring.

The instant disclosure recognizes the need of the individual opening the can to have two functioning hands with fine motor capabilities to open this type of stay-tab beverage can. This may be problematic for individuals who do not possess fine motor capabilities in either of their hands, like the elderly or individuals with physical disabilities in their hands that leaves them without the use of either one or both hands.

In addition, the instant disclosure recognizes that the individual must use their extremities of their hand to lift the tab, like their fingernail or fingertip. This may be problematic for individuals who can't or do not want to sue their extremities of their hand to lift the tab, like an individual who does not want to damage their painted or fake nails.

The instant disclosure may be designed to address at least certain aspects of the problems or needs discussed above by providing a device for opening a canned beverage and a method of use thereof.

### SUMMARY

The present disclosure may solve the aforementioned limitations of the currently available means and/or mechanisms for opening a canned beverage, by providing a device for opening a canned beverage. The device for opening a canned beverage may generally include a main body, a tab cutout and a lifting prong. The main body may have a top, a bottom, a front, and a back. The tab cutout may be positioned in the front of the main body. The tab cutout may be sized and configured to receive the tab of the canned beverage therein. The lifting prong may be positioned inside of the tab cutout. The lifting prong may be configured for sliding under the tab of the canned beverage when the tab is moved into the tab cutout. Whereby, the device may be configured to open the canned beverage by lifting the tab with the lifting prong.

In select embodiments of the disclosed device for opening a canned beverage, the tab cutout may be positioned in a distal end of a protruding portion on the front of the main body. The tab cutout may be positioned on a base of the distal end of the protruding portion of the main body.

One feature of the disclosed device for opening a canned beverage may be that the tab cutout may include a semi-circular shape. The semi-circular shape of the tab cutout may start on the base of the distal end of the protruding portion of the main body. The semi-circular shape of the tab cutout may have an open flat bottom on the base of the distal end of the protruding portion, and a rounded top extending up from the open flat bottom on the base of the distal end of the protruding portion. In select embodiments, the lifting prong may be positioned in the open flat bottom of the semi-circular shape of the tab cutout.

Another feature of the disclosed device for opening a canned beverage may be that the protruding portion can include a rounded top portion and a flat base portion.

In select embodiments of the disclosed device for opening a canned beverage, the protruding portion may be offset from a vertical center of the main body. In these embodiments, a base of the protruding portion may start approximate the vertical center of the main body.

In select embodiments of the disclosed device for opening a canned beverage, the lifting prong may include a triangular cross-section. The triangular cross-section of the lifting prong may have a width, a length and an angled height. The width of the lifting prong may be centered inside of the tab cutout. The angled height of the lifting prong may be greatest at a depth of the tab cutout and may angle downwards to an angled front end of the lifting prong at a start of the tab cutout. The length of the lifting prong may run from the depth of the tab cutout to the start of the tab cutout. In these embodiments with this triangular cross-section of the lifting prong, the angled front end of the lifting prong may be configured to slide under the tab of the canned beverage when the tab is moved into the tab cutout.

Another feature of the disclosed device for opening a canned beverage may be the inclusion of a gripping hole. The gripping hole may be configured to aid in holding, gripping, or manipulating the device. The gripping hole may run through the main body from a left side to a right side. In select embodiments, the gripping hole may be positioned on the main body approximate a proximal end of a protruding portion.

Another feature of the disclosed device for opening a canned beverage may be the ergonomic design of the main body of the device. The ergonomic design of the main body may be configured for allowing the device to be held, gripped and/or manipulated. In select embodiments, the ergonomic design of the main body may include a rounded top end, a rounded bottom end, a rounded upper transition between the main body and a protruding portion, a rounded lower transition between the main body and a base of the protruding portion, the like, and/or combinations thereof. In select possibly preferred embodiments, the ergonomic design of the main body may include the rounded top end, the rounded bottom end, the rounded upper transition between the main body and the protruding portion, and the rounded lower transition between the main body and the base of the protruding portion.

Another feature of the disclosed device for opening a canned beverage may be the inclusion of an attachment mechanism. The attachment mechanism may be configured to attach the device to a surface. In select embodiments, the attachment mechanism may be configured to permanently attach the device to the surface. In other select embodiments, the attachment mechanism may be configured to removably attach the device to the surface. In select possibly preferred embodiments, the attachment mechanism may include a magnet. The magnet may be embedded in the main body approximate the back of the main body in a recess on the back of the main body. The magnet may be configured to removably attach the device to a magnetically attractive surface.

Another feature of the disclosed device for opening a canned beverage may be the inclusion of a protective material. The protective material may be positioned on the back of the main body. The protective material may be configured to protect a surface that the device is attached to or positioned on. In select embodiments, the protective material may be a foam liner attached on the back of the main body.

In select embodiments of the disclosed device for opening a canned beverage, the main body may be made from a plastic material.

Another feature of the disclosed device for opening a canned beverage may be that, when the canned beverage includes a stay-tab opening, the device may be configured for opening the stay-tab opening.

In another aspect, the instant disclosure embraces the device for opening a canned beverage in any embodiment and/or combination of embodiments shown and/or described herein.

In another aspect, the instant disclosure embraces a method of opening a canned beverage. The disclosed method for opening a canned beverage may generally include providing the disclosed device for opening a canned beverage in any embodiment and/or combination of embodiments shown and/or described herein. With the provided device for opening a canned beverage, the method of opening a canned beverage may include: inserting the tab of the canned beverage into the tab cutout; sliding the lifting prong under the tab of the canned beverage; and lifting the tab of the canned beverage via the lifting prong.

In select embodiments of the disclosed method of opening a canned beverage, the method may include: holding the device in one hand; holding the canned beverage in another hand; moving the device into position with the tab cutout positioned approximate the tab of the canned beverage; and with the tab inserted into the tab cutout and the lifting prong slid under the tab of the canned beverage, the lifting the tab of the canned beverage via the lifting prong including rotating the device upwards thereby lifting the tab of the canned beverage with the lifting prong.

In select embodiments of the disclosed method of opening a canned beverage, the method may include: attaching the device to a surface; holding the canned beverage in at least one hand; moving the canned beverage into position with the at least one hand with the tab of the canned beverage positioned approximate the tab cutout; and with the tab inserted into the tab cutout and the lifting prong slid under the tab of the canned beverage, the lifting the tab of the canned beverage via the lifting prong including rotating the canned beverage downwards thereby lifting the tab of the canned beverage with the lifting prong.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a front, bottom, left perspective view of the device for opening a canned beverage according to select embodiments of the instant disclosure;

FIG. 2 is a front, top, right perspective view of the device for opening a canned beverage from FIG. 1;

FIG. 3 is a back, bottom right perspective view of the device for opening a canned beverage from FIG. 1;

FIG. 4 is a front side view of the device for opening a canned beverage from FIG. 1;

FIG. 5 is a left side view of the device for opening a canned beverage from FIG. 1;

FIG. 6 is a back side view of the device for opening a canned beverage from FIG. 1;

FIG. 7 is a bottom side view of the device for opening a canned beverage from FIG. 1;

FIG. 8 is a right side view of the device for opening a canned beverage from FIG. 1;

FIG. 9 is a top side view of the device for opening a canned beverage from FIG. 1;

FIG. 10 is a partially disassembled perspective view of the device for opening a canned beverage according to select embodiments of the instant disclosure;

FIG. 11A is an environmental perspective view of the device for opening a canned beverage according to select embodiments of the instant disclosure being put in position with the lifting prong under the tab of a canned beverage;

FIG. 11B is a zoomed in view of the environmental perspective view of the device for opening a canned beverage of FIG. 11A being put in position with the lifting prong under the tab of the canned beverage;

FIG. 11C is a zoomed in view of an environmental perspective view of the device for opening a canned beverage of FIG. 11A being used to lift the tab;

FIG. 12A is a schematic perspective view of the device for opening a canned beverage according to select embodiments of the instant disclosure next to a canned beverage to be opened;

FIG. 12B is a schematic perspective view of the device for opening a canned beverage according of FIG. 12A being put in position next to the canned beverage to be opened with the device angled upward thereby exposing the lifting prong to the tab;

FIG. 12C is a schematic perspective view of the device for opening a canned beverage according of FIG. 12A with the device in position for opening the canned beverage with the lifting prong inserted under the tab;

FIG. 12D is a schematic perspective view of the device for opening a canned beverage according of FIG. 12A with the device in position opening the canned beverage with the lifting prong inserted under the tab and the device being rotated to lift the tab;

FIG. 12E is a schematic perspective view of the device for opening a canned beverage according of FIG. 12A with the device being removed from the canned beverage after it has been opened;

FIG. 13 is an environmental perspective view of the device for opening a canned beverage according to select embodiments of the instant disclosure positioned on a refrigerator wall via the magnet;

FIG. 14A is a schematic side view of the device for opening a canned beverage according to select embodiments of the instant disclosure positioned on a wall with the canned beverage to be opened next to it;

FIG. 14B is a schematic perspective view of the device for opening a canned beverage according of FIG. 14A positioned on a wall with the canned beverage being put in position with the can angled upward thereby exposing the lifting prong to the tab and the lifting prong positioned under the tab;

FIG. 14C is a schematic perspective view of the device for opening a canned beverage according of FIG. 14A positioned on a wall with the lifting prong inserted under the tab of the can and the can being rotated downward to open the can;

FIG. 14D is a schematic perspective view of the device for opening a canned beverage according of FIG. 14A positioned on a wall with the lifting prong inserted under the tab of the can and the can being rotated completely downward and toward the wall with the can completely open; and

FIG. 15 shows the method of opening a canned beverage with a tab according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

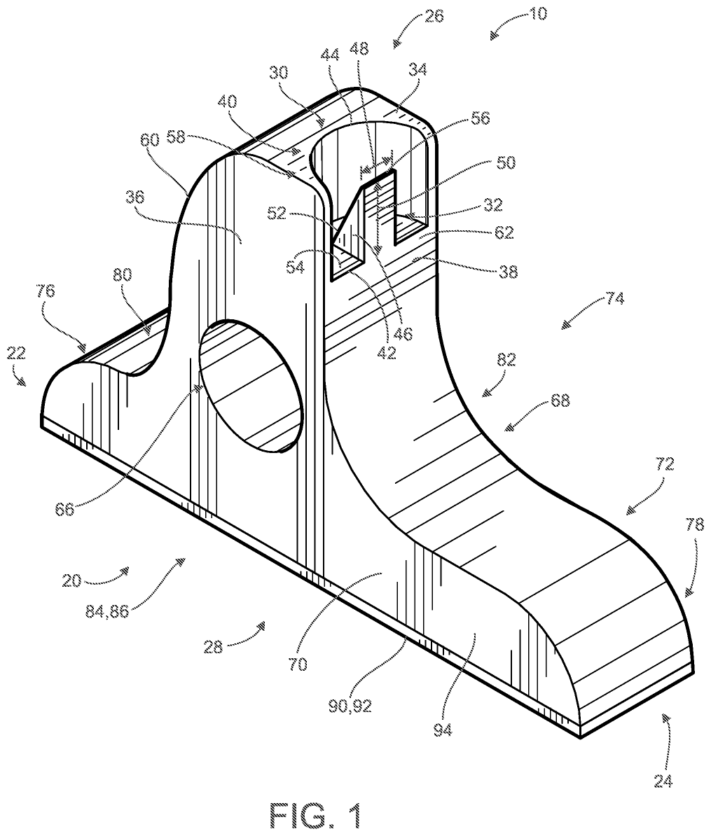

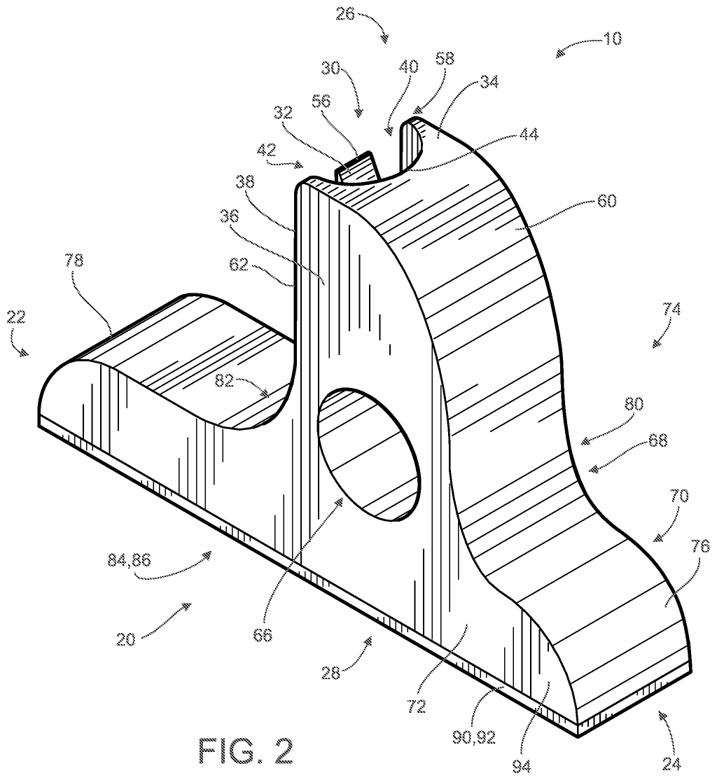

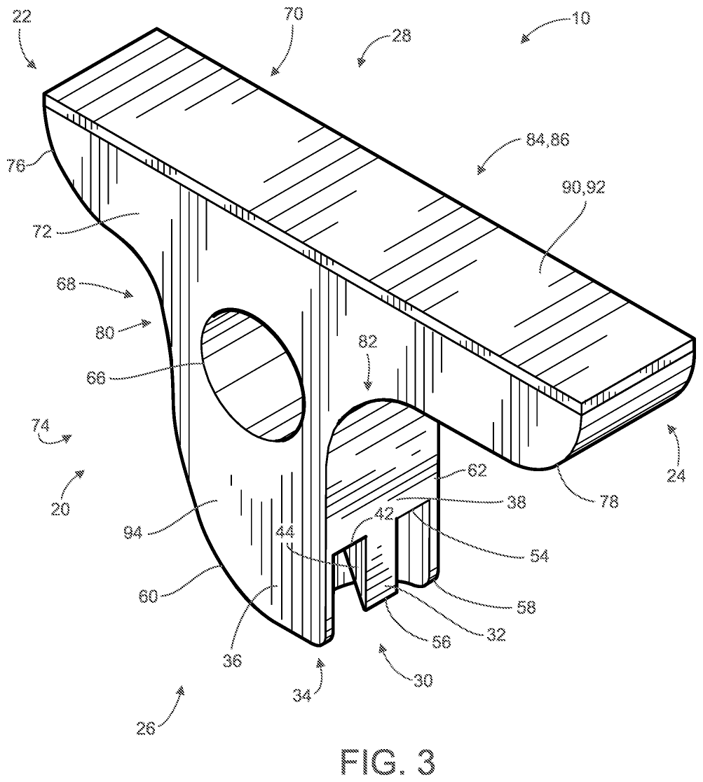

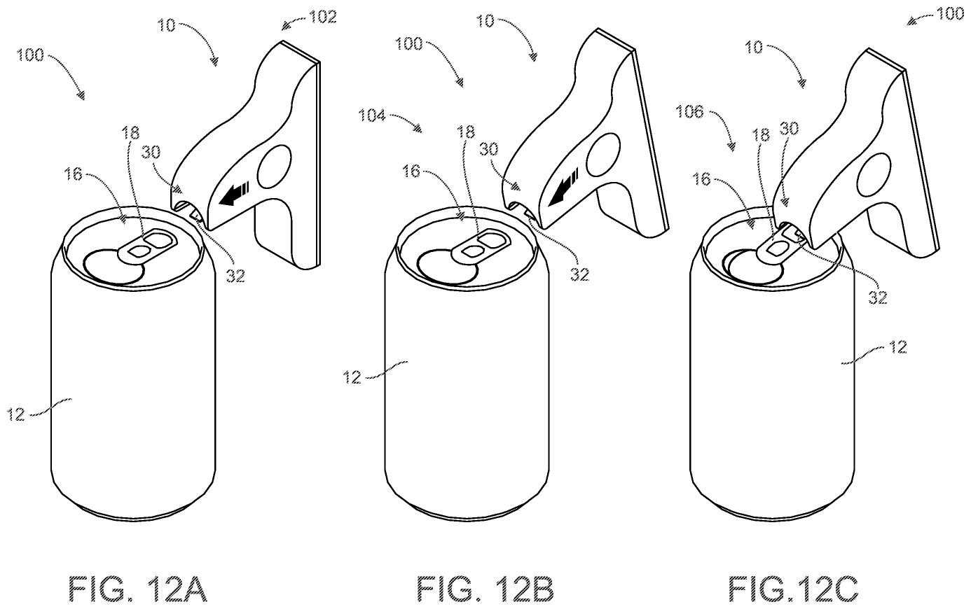

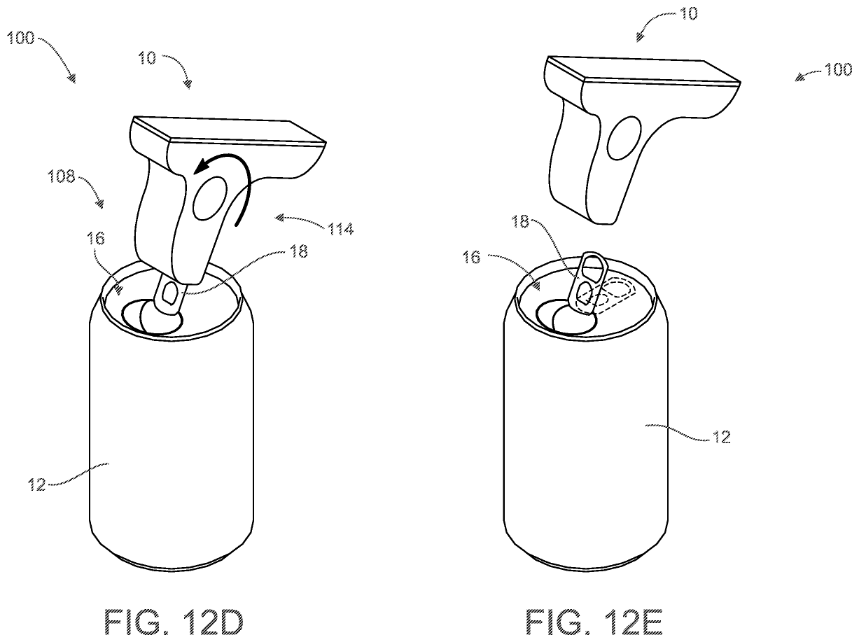

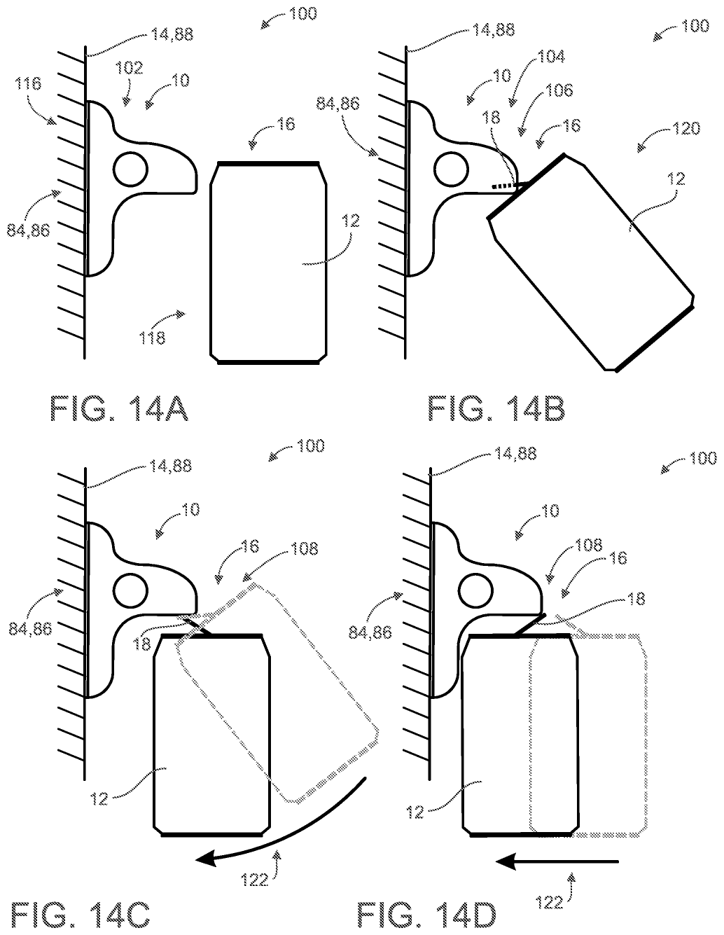

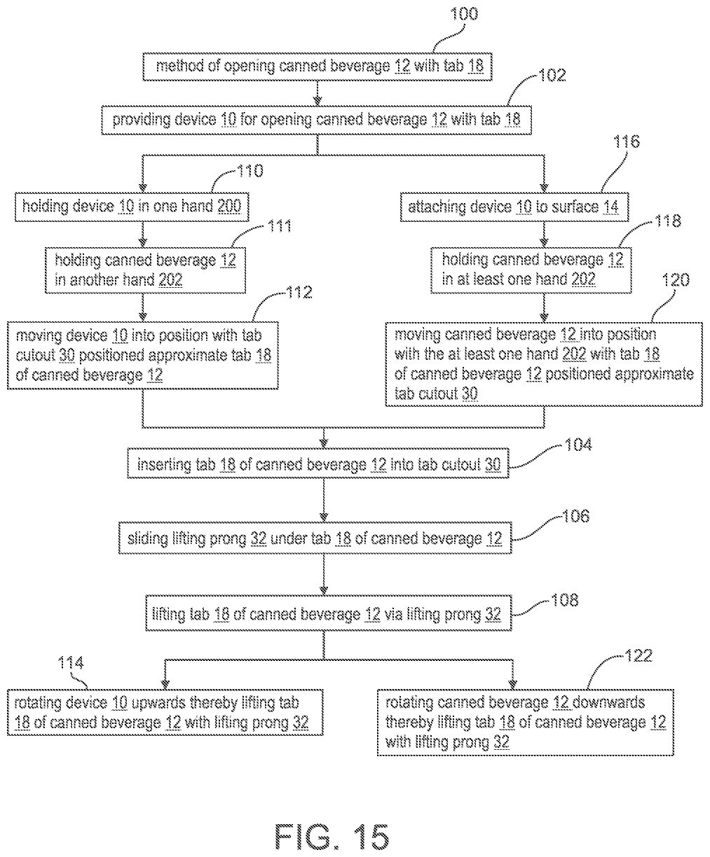

Referring now to FIGS. 1-15, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

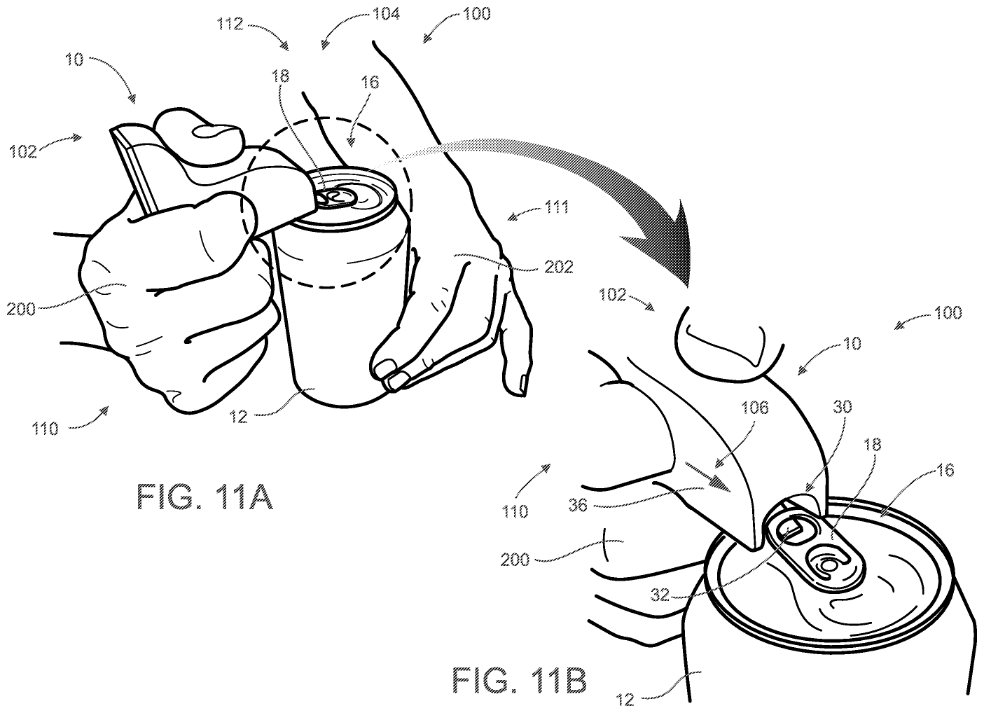

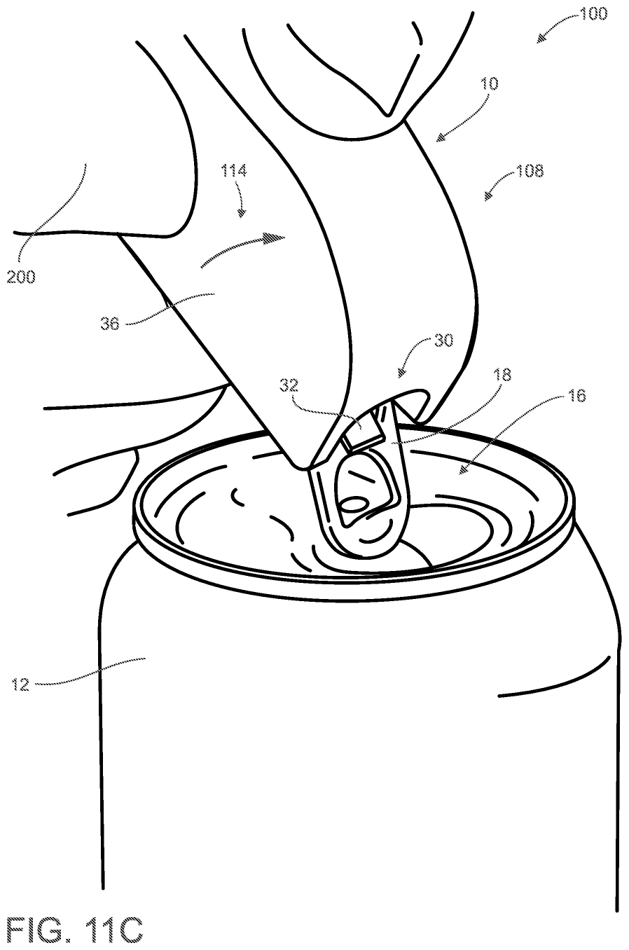

Referring to FIGS. 1-10, the present disclosure may solve the aforementioned limitations of the currently available means and/or mechanisms for opening a canned beverage by providing the disclosed device 10 for opening canned beverage 12. Device 10 for opening canned beverage 12 may generally include main body 20, tab cutout 30 and lifting prong 32. Main body 20 may have top 22, bottom 24, front 26, and back 28. Tab cutout 30 may be positioned in front 26 of main body 20. Tab cutout 30 may be sized and configured to receive tab 18 of canned beverage 12 therein (see FIGS. 11-12 and 14). Lifting prong 32 may be positioned inside of tab cutout 30. Lifting prong 32 may be configured for sliding under tab 18 of canned beverage 12 when tab 18 is moved into tab cutout 30 (see FIGS. 11B, 12C, and 14B). Whereby, device 10 may be configured to open canned beverage 12 by lifting tab 18 with lifting prong 32 (see FIGS. 11C, 12D, 14C and 14D).

As best shown in FIGS. 1, 2, 3, 4, 7, and 10, in select embodiments of device 10 for opening canned beverage 12, tab cutout 30 may be positioned in distal end 34 of protruding portion 36 on front 26 of main body 20. Tab cutout 30 may be positioned on base 38 of distal end 34 of protruding portion 36 of main body 20.

As best shown in FIGS. 1, 2, and 4, in select embodiments of device 10 for opening canned beverage 12, tab cutout 30 may include semi-circular shape 40. Semi-circular shape 40 of tab cutout 30 may start on base 38 of distal end 34 of protruding portion 36 of main body 20. Semi-circular shape 40 of tab cutout 30 may have open flat bottom 42 on base 38 of distal end 34 of protruding portion 36, and rounded top 44 extending up from open flat bottom 42 on base 38 of distal end 34 of protruding portion 36. In select embodiments, lifting prong 32 may be positioned in open flat bottom 42 of semi-circular shape 40 of tab cutout 30.

As shown in FIGS. 1-10, another feature of device 10 for opening canned beverage 12 may be that, in select embodiments, protruding portion 36 can include rounded top portion 60 and flat base portion 62.

As best shown in FIGS. 5 and 8, in select embodiments of device 10 for opening canned beverage 12, protruding portion 36 may be offset from vertical center 64 of main body 20. In these embodiments, base 38 of protruding portion 36 may start approximate vertical center 64 of main body 20.

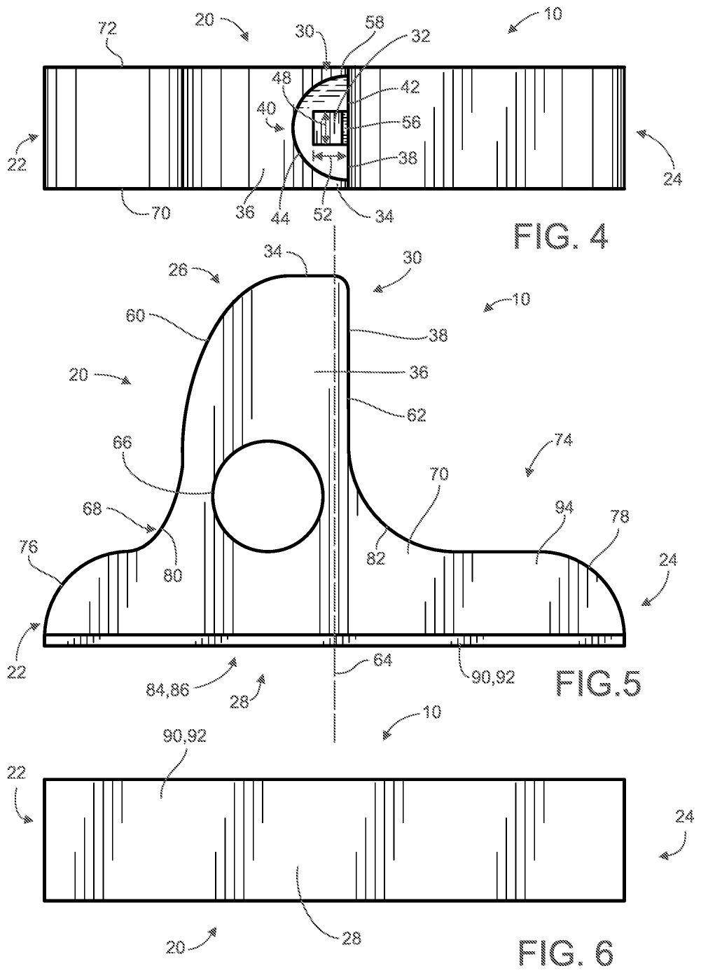

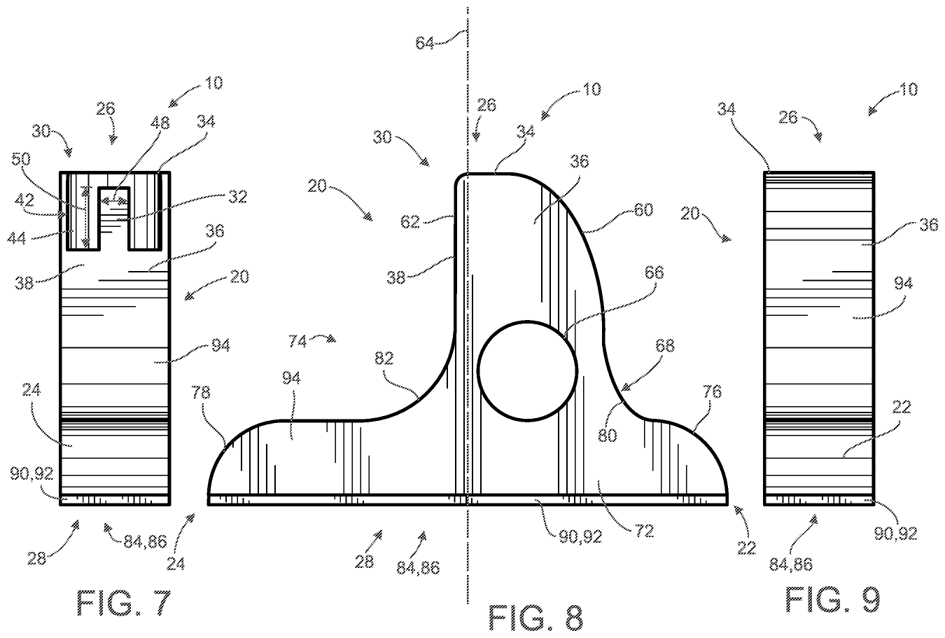

As best shown in FIGS. 1, 2, 3, 4, 7 and 10, in select embodiments of device 10 for opening canned beverage 12, lifting prong 32 may include triangular cross-section 46. Triangular cross-section 46 of lifting prong 32 may have width 48, length 50, and angled height 52. In select embodiments, width 48 of lifting prong 32 may be centered inside of tab cutout 30, as best shown in FIGS. 4 and 7. Angled height 52 of lifting prong 32 may be greatest at depth 54 of tab cutout 30 and may angle downwards to angled front end 56 of lifting prong 32 at start 58 of tab cutout 30. Length 50 of lifting prong 32 may run from depth 54 of tab cutout 30 to start 58 of tab cutout 30. In these embodiments, with this triangular cross-section 46 of lifting prong 32, angled front end 56 of lifting prong 32 may be configured to slide under tab 18 of canned beverage 12, when tab 18 is moved into tab cutout 30.

Referring still to FIGS. 1-10, another feature of device 10 for opening canned beverage 12 may be the inclusion of gripping hole 66. Gripping hole 66 may be configured to aid in holding, gripping, or manipulating device 1-. Gripping hole 66 may run through main body 20 from left side 70 to right side 72. In select embodiments, gripping hole 66 may be positioned on main body 20 approximate proximal end 68 of protruding portion 36, as shown in the Figures.

Referring still to FIGS. 1-10, another feature of device 10 for opening canned beverage 12 may be ergonomic design 74 of main body 20 of device 10. Ergonomic design 74 of main body 20 may be configured for allowing or aiding device 10 to be held, gripped and/or manipulated. In select embodiments, ergonomic design 74 of main body 20 may include rounded top end 76, rounded bottom end 78, rounded upper transition 80 between main body 20 and protruding portion 36, rounded lower transition 82 between main body 20 and base 38 of protruding portion 36, the like, and/or combinations thereof. In select possibly preferred embodiments, as shown in the Figures, ergonomic design 74 of main body 20 may include the combination of rounded top end 76, rounded bottom end 78, rounded upper transition 80 between main body 20 and protruding portion 36, and rounded lower transition 82 between main body 20 and base 38 of protruding portion 36.

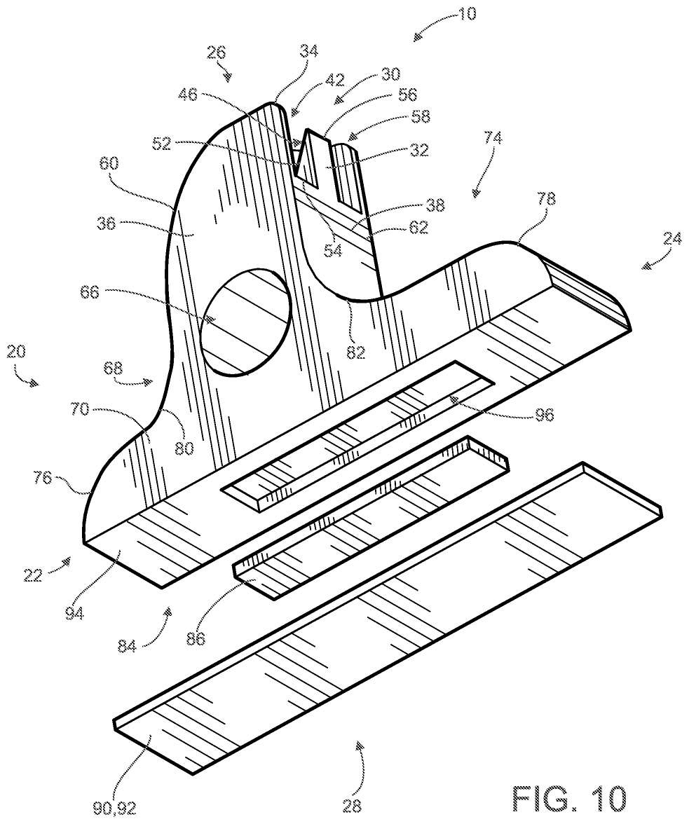

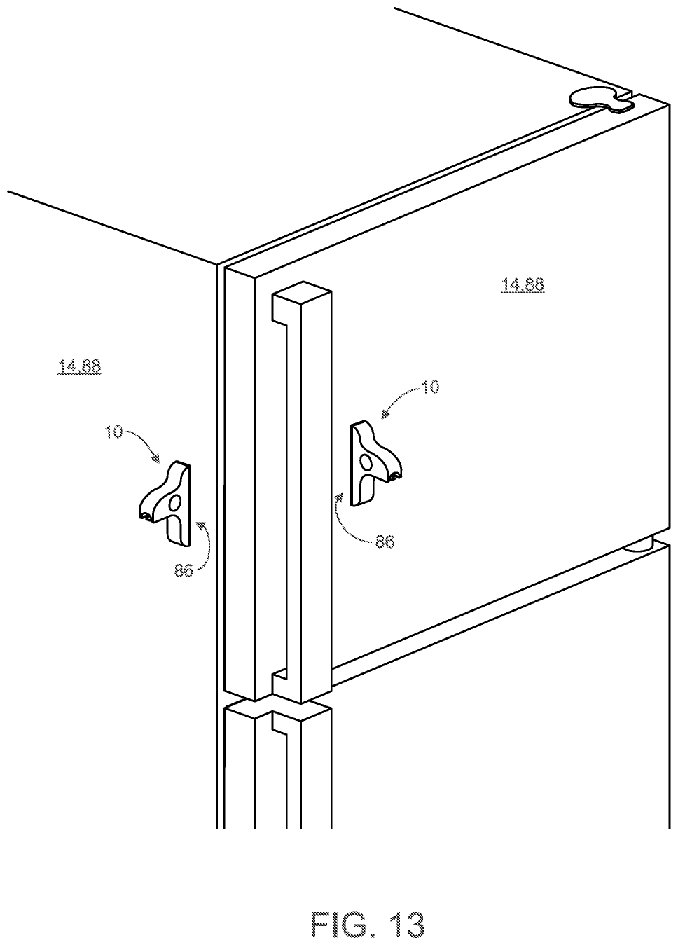

As best shown in FIG. 10, another feature of device 10 for opening canned beverage 12 may be the inclusion of attachment mechanism 84. Attachment mechanism 84 may be configured to attach device 10 to a member, including, but not limited to, like surface 14, a wall, or the like. In select embodiments, attachment mechanism 84 may be configured to permanently attach device 10 to surface 14, a wall, or the like. In other select embodiments, attachment mechanism 84 may be configured to removably attach device 10 to surface 14, a wall, or the like. Attachment mechanism 84 may include any mechanical fastener devices, like nails, screws, bolts, nuts, holes, or the like, or any adhesives, hook and loop fasteners, or the like for permanently attaching device 10 to surface 14, a wall, or the like, or for removably attaching device 10 to surface 14, a wall, or the like. In select possibly preferred embodiments, as best shown in FIG. 10, attachment mechanism 84 may include magnet 86. Magnet 86 may be embedded in main body 20 approximate back 28 of main body 20 in recess 96 on back 28 of main body 20. As shown in FIG. 13, magnet 86 may be configured to removably attach device 10 to magnetically attractive surface 88, including, but not limited to, a refrigerator door or side wall as shown.

Still referring to FIGS. 1-10, another feature of device 10 for opening canned beverage 12 may be the inclusion of protective material 90. Protective material 90 may be positioned on back 28 of main body 20. Protective material 90 may be configured to protect surface 14, a wall, or the like, that device 10 may be attached to or positioned on. In select embodiments, protective material 90 may be foam liner 92 attached on back 28 of main body 20, as shown in the Figures.

In select embodiments of device 10 for opening canned beverage 12, main body 20 may be made from plastic material 94. However, the disclosure is not so limited, and main body 20 may be made of any desired material, including, but not limited to, any rubbers, metals, the like, etc.

As shown in FIGS. 11-12 and 14, another feature of device 10 for opening canned beverage 12 may be that, when canned beverage 12 includes stay-tab opening 16, device 10 may be configured for opening stay-tab opening 16. However, the disclosure is not so limited, and device 10 may be configured for opening any canned beverage, or the like, with a tab, or other like device configured for opening.

Referring now to FIGS. 11-15, in another aspect, the instant disclosure embraces method 100 of opening canned beverage 12. Method 100 for opening canned beverage 12 may generally include step 102 of providing the disclosed device 10 for opening canned beverage 12, or the like, in any embodiment and/or combination of embodiments shown and/or described herein. With the provided device 10 for opening canned beverage 12, method 100 of opening canned beverage 12 may include: step 104 of inserting tab 18 of canned beverage 12 into tab cutout 30; step 106 of sliding lifting prong 32 under tab 18 of canned beverage 12; and step 108 of lifting tab 18 of canned beverage 12 via lifting prong 32.

Referring specifically to FIGS. 11-12 and 15, in select embodiments of method 100 of opening canned beverage 12, method 100 may include: step 110 of holding device 10 in one hand 200; step 111 of holding canned beverage 12 in another hand 202; step 112 of moving device 10 into position with tab cutout 30 positioned approximate tab 18 of canned beverage 12 (either via hand 200 manipulating device 10 and/or another hand 202 manipulating canned beverage 12); and with tab 18 inserted into tab cutout 30 and lifting prong 32 slid under tab 18 of canned beverage 12, step 108 of lifting tab 18 of canned beverage 12 via lifting prong 32 may include step 114 of rotating device 10 upwards thereby lifting tab 18 of canned beverage 12 with lifting prong 32.

Referring specifically to FIGS. 13-15, in select embodiments of method 100 of opening canned beverage 12, method 100 may include: step 116 of attaching device 10 to surface 14 (like magnetically attractive surface 88, including, but not limited to, a refrigerator door or side panel); step 118 of holding canned beverage 12 in at least one hand 200; step 120 of moving canned beverage 12 into position with the at least one hand 200 with tab 18 of canned beverage 12 positioned approximate tab cutout 30; and with tab 18 inserted into tab cutout 30 and lifting prong 32 slid under tab 18 of canned beverage 12, step 108 of lifting tab 18 of canned beverage 12 via lifting prong 32 may include step 198 of rotating canned beverage 12 downwards thereby lifting tab 18 of canned beverage 12 with lifting prong 32.

In sum, the intended purpose of device 10 for opening canned beverage 12 may be to make canned beverages accessible to those individuals who do not possess fine motor capabilities of their hand, and/or do not wish to use the extremities on their hand to lift tab 18 of canned beverage 12 in order to open said beverage 12. Device 10 may also be intended to be used vertically attached to surface 14, a wall, or the like.

A feature of the disclosed device 10 for opening canned beverage 12 may be its ability to allow one handed openings of canned beverages. The advantage of the aforementioned feature is it may allow individuals to quickly and effortlessly open canned beverages, without the need to bind both hands to the task. The advantage of this, may be that it can allow the individual to complete the task of opening canned beverage 12 without having to interrupt any additional tasks the individual may be in the process of doing.

Another feature of the disclosed device 10 for opening canned beverage 12 may be its ability to allow individuals to open canned beverage 12 without the need to hold the tool in one's hand. There are multiple advantages to this, the first being it frees up both hands to be used if necessary. For example, an elderly individual may need to use both hands in order to have the physical strength and dexterity to open canned beverage 12. Another example may be an individual who has some physical disability that leaves them without either one or both hands, which ultimately would lead them to not be able to enjoy canned beverage 12.

Another feature of the disclosed device 10 for opening canned beverage 12 may be its ability to be semi or permanently attached to surface 14, a wall, or the like. The advantage of this is it may allow the individual to place device 10 in an obvious place in the hopes that they would not lose device 10. Another advantage is it allows device 10 to be readily accessible to those individuals who wish to take advantage of device 10.

Another feature of the disclosed device 10 may be its ability to be attached to surface 14, a wall, or the like, via the internal magnet 86 that is embedded in device 10. The advantage of this is it allows device 10 to be mounted to magnetically attracted surface 88 (like a refrigerator door or side wall) without having to use external hardware, which will help to save the integrity of not only device 10, but surface 14 to which it shall be applied.

Another feature of the disclosed device 10 may be the foam liner 92 as protective material 90 on back 28 of main body 20 of device 10. The advantage of this is it allows device 10 to be attached to surface 14, a wall, or the like, without the worry of damaging surface 14, the wall, or the like.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A device for opening a canned beverage with a tab, the device comprising:
a main body with a top, a bottom, a front, and a back;
a tab cutout positioned in the front of the main body, the tab cutout is sized and configured to receive the tab of the canned beverage therein;
a lifting prong positioned inside of the tab cutout, the lifting prong is configured for sliding under the tab of the canned beverage when the tab is moved into the tab cutout; and
whereby, the device is configured to open the canned beverage by lifting the tab with the lifting prong.

2. The device of claim 1, wherein the tab cutout is positioned in a distal end of a protruding portion on the front of the main body, wherein the tab cutout is positioned on a base of the distal end of the protruding portion of the main body.

3. The device of claim 2, wherein the tab cutout including a semi-circular shape starting on the base of the distal end of the protruding portion of the main body, where the semi-circular shape of the tab cutout has an open flat bottom on the base of the distal end of the protruding portion, and a rounded top extending up from the open flat bottom on the base of the distal end of the protruding portion;
wherein the lifting prong is positioned in the open flat bottom of the semi-circular shape of the tab cutout.

4. The device of claim 2, wherein the protruding portion including a rounded top portion and a flat base portion;
wherein the protruding portion is offset from a vertical center of the main body, where a base of the protruding portion starts approximate the vertical center of the main body.

5. The device of claim 1, wherein the lifting prong including a triangular cross-section with a width, a length and an angled height, wherein:
the width of the lifting prong is centered inside of the tab cutout;
the angled height of the lifting prong is greatest at a depth of the tab cutout and angles downwards to an angled front end of the lifting prong at a start of the tab cutout;
the length of the lifting prong runs from the depth of the tab cutout to the start of the tab cutout; and
wherein, the angled front end of the lifting prong is configured to slide under the tab of the canned beverage when the tab is moved into the tab cutout.

6. The device of claim 1, wherein the main body having a gripping hole therethrough, the gripping hole is configured to aid in holding, gripping, or manipulating the device.

7. The device of claim 6, wherein the gripping hole is positioned on the main body approximate a proximal end of a protruding portion, the gripping hole runs through the main body from a left side to a right side.

8. The device of claim 1, wherein the main body including an ergonomic design configured for being held, gripped and manipulated.

9. The device of claim 8, wherein the ergonomic design of the main body including:
a rounded top end;
a rounded bottom end;
a rounded upper transition between the main body and a protruding portion;
a rounded lower transition between the main body and a base of the protruding portion; or
combinations thereof.

10. The device of claim 9, wherein the ergonomic design of the main body including:
the rounded top end;
the rounded bottom end;
the rounded upper transition between the main body and the protruding portion; and
the rounded lower transition between the main body and the base of the protruding portion.

11. The device for opening a canned beverage of claim 1 further comprising an attachment mechanism, the attachment mechanism is configured to attach the device to a surface, wherein the attachment mechanism is configured to permanently attach the device to the surface or to removably attach the device to the surface.

12. The device of claim 11, wherein the attachment mechanism including a magnet embedded in the main body approximate the back of the main body in a recess in the back of the main body, the magnet is configured to removably attach the device to a magnetically attractive surface.

13. The device of claim 1 further comprising a protective material positioned on the back of the main body, the protective material is configured to protect a surface that the device is attached to or positioned on.

14. The device of claim 13, wherein the protective material is a foam liner attached on the back of the main body.

15. The device of claim 14, wherein the main body is made from a plastic material.

16. The device of claim 1, wherein the canned beverage including a stay-tab opening with the tab, whereby, the device is configured for opening the stay-tab opening via the lifting prong lifting the tab of the stay-tab opening.

17. A device for opening a canned beverage with a stay-tab opening with a tab, the device comprising:
a main body with a top, a bottom, a front, and a back;
a protruding portion on the front of the main body, the protruding portion including a rounded top portion and a flat base portion, the protruding portion is offset from a center of the main body between the center of the main body and the top of the main body;
a tab cutout positioned in the front of the main body, the tab cutout is sized and configured to receive the tab of the canned beverage therein, the tab cutout is positioned in a distal end of the protruding portion on the front of the main body, the tab cutout is positioned on the flat base of the distal end of the protruding portion of the main body, the tab cutout including:
a semi-circular shape starting on the flat base of the distal end of the protruding portion of the main body, where the semi-circular shape of the tab cutout has an open flat bottom on the flat base of the distal end of the protruding portion, and a rounded top extending up from the open flat bottom on the flat base of the distal end of the protruding portion;
a lifting prong positioned inside of the tab cutout, the lifting prong is configured for sliding under the tab of the canned beverage when the tab is moved into the tab cutout, the lifting prong is positioned in the open flat bottom of the semi-circular shape of the tab cutout, the lifting prong including a triangular cross-section with a width, a length and an angled height, wherein:
the width of the lifting prong is centered inside of the tab cutout;
the angled height of the lifting prong is greatest at a depth of the tab cutout and angles downwards to an angled front end of the lifting prong at a start of the tab cutout, the angled front end of the lifting prong is configured to slide under the tab of the canned beverage when the tab is moved into the tab cutout;
the length of the lifting prong runs from the depth of the tab cutout to the start of the tab cutout;
a gripping hole therethrough the main body, the gripping hole is configured to aid in holding, gripping, or manipulating the device, the gripping hole is positioned on the main body approximate a proximal end of the protruding portion, the gripping hole runs through the main body from a left side to a right side;
an attachment mechanism, the attachment mechanism is configured to attach the device to a surface, wherein the attachment mechanism including a magnet embedded in the main body approximate the back of the main body, the magnet is configured to removably attach the device to a magnetically attractive surface;
a protective material positioned on the back of the main body, the protective material is configured to protect a surface that the device is attached to or positioned on, wherein the protective material is a foam liner attached on the back of the main body;
wherein, the main body including an ergonomic design configured for being held, gripped and manipulated, the ergonomic design of the main body including:
a rounded top end;
a rounded bottom end;
a rounded upper transition between the main body and a protruding portion;
a rounded lower transition between the main body and a base of the protruding portion; and
whereby, the device is configured to open the stay-tab opening of the canned beverage by lifting the tab of the stay-tab opening with the lifting prong.

18. A method of opening a canned beverage with a tab comprising:
providing a device for opening a canned beverage with a tab, the device comprising:
a main body with a top, a bottom, a front, and a back;
a tab cutout positioned in the front of the main body, the tab cutout is sized and configured to receive the tab of the canned beverage therein;
a lifting prong positioned inside of the tab cutout, the lifting prong is configured for sliding under the tab of the canned beverage when the tab is moved into the tab cutout;
whereby, the device is configured to open the canned beverage by lifting the tab with the lifting prong.
inserting the tab of the canned beverage into the tab cutout;
sliding the lifting prong under the tab of the canned beverage; and
lifting the tab of the canned beverage via the lifting prong.

19. The method of claim 18 further comprising:
holding the device in one hand;
holding the canned beverage in another hand;
moving the device into position with the tab cutout positioned approximate the tab of the canned beverage; and
with the tab inserted into the tab cutout and the lifting prong slid under the tab of the canned beverage, the lifting the tab of the canned beverage via the lifting prong including rotating the device upwards thereby lifting the tab of the canned beverage with the lifting prong.

20. The method of claim 18 further comprising:
attaching the device to a surface;
holding the canned beverage in at least one hand;
moving the canned beverage into position with the at least one hand with the tab of the canned beverage positioned approximate the tab cutout;
with the tab inserted into the tab cutout and the lifting prong slid under the tab of the canned beverage, the lifting the tab of the canned beverage via the lifting prong including rotating the canned beverage downwards thereby lifting the tab of the canned beverage with the lifting prong.
